(19) United States
(12) Patent Application Publication
(10) Pub. No.: US 2024/0430654 A1
(43) Pub. Date: Dec. 26, 2024

(54) NOTIFICATION APPARATUS, NOTIFICATION METHOD, AND NON-TRANSITORY STORAGE MEDIUM

(71) Applicant: NEC Corporation, Minato-ku, Tokyo (JP)

(72) Inventors: Masahiro Tani, Tokyo (JP); Kazufumi Kojima, Tokyo (JP); Keisuke Ikeda, Tokyo (JP)

(73) Assignee: NEC Corporation, Minato-ku, Tokyo (JP)

(21) Appl. No.: 18/698,924

(22) PCT Filed: Oct. 28, 2021
(86) PCT No.: PCT/JP2021/039784

§ 371 Date: Apr. 5, 2024

(51) Int. Cl. H04W 4/90; H04L 67/30

(52) U.S. Cl. CPC H04W 4/90; H04L 67/30

(57) ABSTRACT

The present invention provides a notification apparatus (10) including an activity range estimation unit (11) that generates location information indicating an activity range of a user of an account, based on public information that is associated with the account and is available on the Internet, and a notification unit (12) that transmits notification information to a user of the account for which the location information satisfies a first notification condition.

### TECHNICAL FIELD

The present invention relates to a notification apparatus, a notification method, and a program.

### TECHNICAL FIELD

A technique related to the present invention is disclosed in Patent Documents 1 to 6 and Non-Patent Documents 1 to 6.

Patent Document 1 discloses a technique for sensing disaster occurrence from a message posted on social media such as social networking service (SNS), or the like.

Patent Document 2 discloses a technique for generating a hazard map, based on a message posted on social media, or the like, when a disaster occurs.

Patent Document 3 and Non-Patent Documents 1 to 4 each disclose a technique for estimating, based on a friendship relationship, an activity range of a user who has an account on social media.

Patent Documents 4 to 6, and Non-Patent Documents 5 and 6 each disclose a technique for determining an account of social media owned by the same person.

### RELATED DOCUMENT

### Patent Document

Patent Document 1: Japanese Patent Application Publication No. 2016-212751

Patent Document 2: Japanese Patent Application Publication No. 2019-109730

Patent Document 3: International Patent Publication No. WO2021/028988

Patent Document 4: International Patent Publication No. WO2019/187107

Patent Document 5: International Patent Publication No. WO2019/234827

Patent Document 6: Japanese Patent Application Publication No. 2013-122630

### Non-Patent Document

Non-Patent Document 1: “Study of residential area estimation method focusing on geographical proximity of friend groups” written by Keisuke Ikeda, Kazufumi Kojima, Masahiro Tani, The Institute of Electronics, Information and Communication Engineers, IEICE Technical Report, Vol. 119, No. 317, pp. 37 to 42, AI2019-36, November 2019

Non-Patent Document 2: “Graph-based residence location inference for social media users” written by Dan Xu, Peng Cui, Wenwu Zhu, Shiqiang Yang, IEEE Computer Society, IEEE MultiMedia, Volume 21, Issue 4, pp 76 to 83, October 2014

Non-Patent Document 3: “Find me if you can: Improving geographical prediction with social and spatial proximity” written by Backstrom Lars, Eric Sun, Cameron Marlow, Proceedings of the 19th international conference on World Wide Web, 2010, pp. 61 to 70

Non-Patent Document 4: “Closeness and structure of friends help to estimate user locations” written by Liu Zhi, Yan Huang, International Conference on Database Systems for Advanced Applications, Springer, pp. 33 to 48

Non-Patent Document 5: Y. Li, Y. Peng, W. Ji, Z. Zhang, and Q. Xu, “User Identification Based on Display Names Across Online Social Networks”, IEEE Access, vol. 5, pp. 17342 to 17353, Aug. 25, 2017

Non-Patent Document 6: X. Han, X Liang and et al. “Linking social network accounts by modeling user spatiotemporal habits”, Intelligence and Security Informatics (ISI), IEEE International Conference on, 2017

### DISCLOSURE OF THE INVENTION

### Technical Problem

By notifying an appropriate user of appropriate information, inconvenience of the user being involved in a trouble such as a disaster, an accident, an incident, and a congestion can be reduced. When all users are notified of all pieces of information, a processing load on a computer that executes processing of notifying of the information is increased. Further, the user is notified not only of related information but also of unrelated information. As a result, attention of the user to information to be notified of is reduced, and inconvenience such as overlooking important information may occur. None of Patent Documents 1 to 6 and Non-Patent Documents 1 to 6 disclose this problem.

An object of the present invention is to notify an appropriate user of appropriate information.

### Solution to Problem

The present invention provides a notification apparatus including:
an activity range estimation unit that generates location information indicating an activity range of a user of an account, based on public information that is associated with the account and is available on the Internet: and
a notification unit that transmits notification information to a user of the account for which the location information satisfies a first notification condition.

Further, the present invention provides a notification method including, executing by a computer:
an activity range estimation process of generating location information indicating an activity range of a user of an account, based on public information that is associated with the account and is available on the Internet: and
a notification process of transmitting notification information to a user of the account for which the location information satisfies a first notification condition.

Further, the present invention provides a program causing a computer to function as:
an activity range estimation unit that generates location information indicating an activity range of a user of an account, based on public information that is associated with the account and is available on the Internet: and
a notification unit that transmits notification information to a user of the account for which the location information satisfies a first notification condition.

### Advantageous Effects of Invention

According to the present invention, an appropriate user can be notified of appropriate information.

### BRIEF DESCRIPTION OF THE DRAWINGS

FIG. 1 It is a diagram illustrating one example of a hardware configuration of a notification apparatus according to the present example embodiment.

FIG. 2 It is one example of a functional block diagram of the notification apparatus according to the present example embodiment.

FIG. 3 It is a flowchart illustrating one example of a flow of processing of the notification apparatus according to the present example embodiment.

FIG. 4 It is one example of a functional block diagram of the notification apparatus according to the present example embodiment.

FIG. 5 It is a diagram schematically illustrating one example of information that the notification apparatus according to the present example embodiment processes.

FIG. 6 It is a flowchart illustrating one example of a flow of processing of the notification apparatus according to the present example embodiment.

FIG. 7 It is one example of a functional block diagram of the notification apparatus according to the present example embodiment.

FIG. 8 It is a flowchart illustrating one example of a flow of processing of the notification apparatus according to the present example embodiment.

FIG. 9 It is one example of a functional block diagram of the notification apparatus according to the present example embodiment.

FIG. 10 It is a flowchart illustrating one example of a flow of processing of the notification apparatus according to the present example embodiment.

### DESCRIPTION OF EMBODIMENTS

Hereinafter, an example embodiment of the present invention is described by use of the drawings. Note that, in all of the drawings, a similar component is assigned with a similar reference sign, and description thereof is omitted as appropriate.

### First Example Embodiment

### “Outline”

First, an outline of a notification apparatus according to the present example embodiment is described. The notification apparatus generates location information indicating a real-world activity range of a user of an account of social media such as SNS, based on public information that is associated with the account and is available on the Internet. Then, the notification apparatus transmits notification information to a user of an account for which the location information satisfies a first notification condition. In this way, the notification apparatus according to the present example embodiment transmits notification information to a user of an account for which an activity range estimated based on public information available on social media satisfies a predetermined condition. With such a configuration, it becomes possible to notify an appropriate user of appropriate information.

### “Hardware Configuration”

Next, one example of the hardware configuration of the notification apparatus is described. Each functional unit of the notification apparatus is achieved by any combination of hardware and software mainly including a central processing unit (CPU) of any computer, a memory, a program loaded onto the memory, a storage unit such as a hard disk that stores the program (that can store not only a program stored in advance from a phase of shipping an apparatus but also a program downloaded from a storage medium such as a CD or a server or the like on the Internet), and an interface for network connection. Then, it is appreciated by a person skilled in the art that there are a variety of modified examples of a method and an apparatus for the achievement.

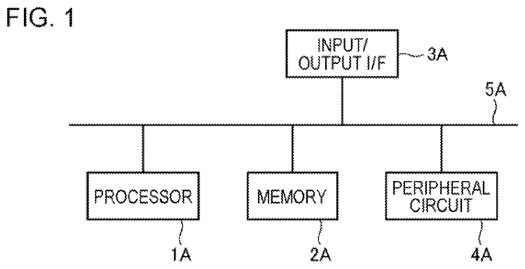

FIG. 1 is a block diagram illustrating a hardware configuration of the notification apparatus. As illustrated in FIG. 1, the notification apparatus includes a processor IA, a memory 2A, an input/output interface 3A, a peripheral circuit 4A, and a bus 5A. The peripheral circuit 4A includes various modules. The notification apparatus may not have the peripheral circuit 4A. Note that, the notification apparatus may be configured by a plurality of physically and/or logically separated apparatuses. In this case, each of the plurality of apparatuses can include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, or the like. The processor 1A can give an instruction to each of modules, and perform an arithmetic operation, based on an arithmetic result of each of the modules.

### “Function Configuration”

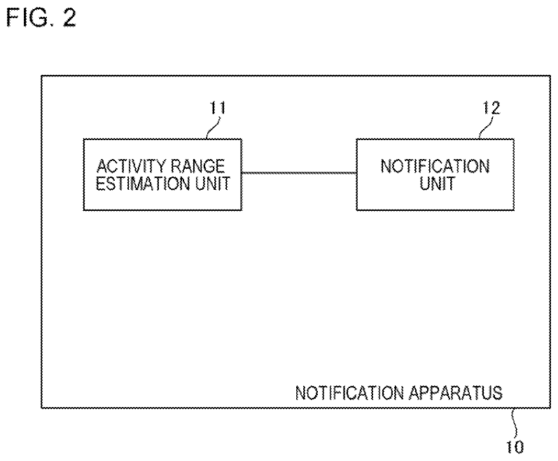

Next, a functional configuration of the notification apparatus is described. FIG. 2 illustrates one example of a functional block diagram of a notification apparatus 10. As illustrated, the notification apparatus 10 includes an activity range estimation unit 11 and a notification unit 12.

The activity range estimation unit 11 generates location information indicating an activity range of a user of an account of social media, based on public information that is associated with the account and is available on the Internet.

The “public information” can include any information that is associated with each user on social media and is available. For example, public information includes at least one of a profile of each user, a posted matter posted by each user, relationship information indicating a relationship with another user on social media, a profile of another user having a predetermined relationship with each user on social media, and a posted matter posted by the another user.

An item included in “profile” may differ for each social media, but may include, for example, a user name, a nickname, a gender, a date of birth, a nationality, an age (or a generation), a place of birth, a current place of residence, an affiliation, a school attended, and the like.

The “posted matter” is a message, a still image, a moving image, a sound, or the like.

The “relationship information” is information indicating a connection with another user on social media. For example, relationship information may indicate at least one of another user having a mutually following relationship with each user, another user followed by each user, another user who follows each user, and another user having an exchange history of a message with each user.

“Another user having a predetermined relationship with each user” is at least one of, for example, another user having a mutually following relationship with each user, another user followed by each user, another user who follows each user, and another user having an exchange history of a message with each user.

The “activity range” is a geographical range in which a user acts in a real world, and is indicated by a municipality, a range wider than that, or a range narrower than that.

The activity range estimation unit 11 acquires the public information from a server that provides a service of social media. Then, the activity range estimation unit 11 generates location information indicating an activity range of a user of each account, based on the acquired public information. A way of computing an activity range of a user for each account is not particularly limited, and any technique such as techniques disclosed in, for example, Patent Document 3 and Non-Patent Documents 1 to 4 can be adopted.

Note that, the activity range estimation unit 11 may determine a plurality of accounts owned by the same user. Then, in computation of an activity range of a user of a certain account, not only public information that is associated with the account and is available, but also public information that is associated with an account of another user and is available may also be further utilized. Utilizing more pieces of public information improves estimation accuracy of an activity range. A way of determining a plurality of accounts owned by the same user is not particularly restricted, and any technique such as techniques disclosed in, for example, Patent Documents 4 to 6 and Non-Patent Documents 5 and 6 can be adopted.

The notification unit 12 transmits notification information to a user of an account for which location information generated by the activity range estimation unit 11 satisfies a first notification condition.

The “notification information” is information that calls attention in such a way to avoid being involved in a trouble such as a disaster, an accident, an incident, a fire, and a congestion. The notification information is constituted of text data, still image data, moving image data, sound data, and the like.

The “first notification condition” is that an activity range indicated by location information has a predetermined relationship with a notification target area, and is, for example, “at least a part of an activity range indicated by location information is included in a notification target area” or “the entire activity range indicated by location information is included in a notification target area”.

The “notification target area” is an area targeted for notification. The notification apparatus 10 may determine a notification target area based on predetermined information acquired from an external server or the like, or an operator of the notification apparatus 10 may input information indicating the notification target area to the notification apparatus 10.

Herein, an example of notification information and a notification target area is explained.

### Example 1

In a case of this example, notification information is information calling attention in response to occurrence of an earthquake. An example of the notification information in this case is exemplified by “an earthquake occurred at 9:15 a.m. An earthquake center is ○○, and seismic intensity in ○○ City is 4. Please be careful of an aftershock.”, or the like. A notification target area in this case is an area affected by the earthquake, and may be, for example, an area where seismic intensity is equal to or more than a criterion value.

In a case of this example, the notification unit 12 may acquire information indicating seismic intensity in each region from an external server (a server that provides earthquake information), and determine the notification target area, based on the information. Alternatively, an operator of the notification apparatus 10 may input information indicating a notification target area to the notification apparatus 10.

### Example 2

In a case of this example, notification information is information that calls attention in response to occurrence of work on a road such as a traffic accident, a road construction, or road cleaning. An example of notification information in this case is exemplified by “A traffic accident occurred at ○○ intersection at 10:03 a.m. Congestion is expected in a periphery for a while.”, “A road construction is performed at ○○ intersection from 10:00 a.m. to 3:00 p.m. During the time, congestion is expected in a periphery.”, “From 10:00 a.m. to 11:00 a.m., road cleaning is performed at ○○ intersection. During the time, congestion is expected in a periphery.”, or the like. A notification target area in this case is a peripheral area of the work occurrence point.

In a case of this example, the notification unit 12 may acquire information relating to a traffic accident, a road construction, road cleaning, or the like (information indicating an occurrence point, a schedule, or the like) from an external server (a server that provides traffic accident information, or a server that provides a schedule of a road construction or road cleaning), and determine a notification target area, based on the information. Alternatively, an operator of the notification apparatus 10 may input, to the notification apparatus 10, information indicating a notification target area.

### Example 3

In a case of this example, the notification information is information that calls attention in response to occurrence of an incident such as snatching, robbery, burglary, or kidnapping. An example of notification information in this case is exemplified by “a snatching incident occurred in ○○ town at 10:18 a.m. Please be careful”. A notification target area in this case is a peripheral area of the incident occurrence point.

In a case of this example, the notification unit 12 may acquire information relating to an incident (such as information indicating an occurrence point) from an external server (a server that provides incident information), and determine a notification target area, based on the information. Alternatively, an operator of the notification apparatus 10 may input information indicating the notification target area to the notification apparatus 10.

### Example 4

In a case of this example, the notification information is information that calls attention in response to occurrence of a fire. An example of notification information in this case is exemplified by “a fire occurred in ○○ town at 10:21 a.m. Please be careful as it is dangerous. Further, congestion is expected in a periphery.”. A notification target area in this case is a peripheral area of the fire occurrence point.

In a case of this example, the notification unit 12 may acquire information relating to the fire (such as information indicating an occurrence point) from an external server (a server that provides fire information), and determine a notification target area, based on the information. Alternatively, an operator of the notification apparatus 10 may input information indicating a notification target area to the notification apparatus 10.

### Example 5

In a case of this example, the notification information is information that calls attention in such a way as not to be involved in an illegal part-time job, a bank transfer fraud, or the like. The notification information may be transmitted periodically (once a week, or once a day), or may be transmitted at a timing when an operator of the notification apparatus 10 inputs a transmission instruction. An example of notification information in this case is exemplified by “Recently, there has been an increase in incidents related to illegal part-time jobs. Please be careful not to be involved. Please be careful.”, “Recently, there has been an increase in bank transfer frauds. Please be careful not to be involved. Please be careful.”, or the like. A notification target area in this case is, for example, a jurisdiction of an organization that performs attention calling using notification information.

In a case of this example, an operator of the notification apparatus 10 may input information indicating a notification target area to the notification apparatus 10.

Transmission of notification information to a predetermined user may be achieved by utilizing a social media service. In other words, an account of a social media may be prepared in advance for notification information transmission. Then, the notification unit 12 may utilize the account and transmit notification information to an account of a predetermined user. In addition, when another contact point of a user of each account (e.g., an e-mail address, a phone number, user identification information for another application, or the like) is acquirable (e.g., included in public information that is associated with an account of another user and is available on the Internet, or registered in advance in the notification apparatus 10, or the like), the notification unit 12 may notify a predetermined user of notification information by a means such as transmission of an e-mail, making a phone call, or notification (push notification or the like) utilizing another application.

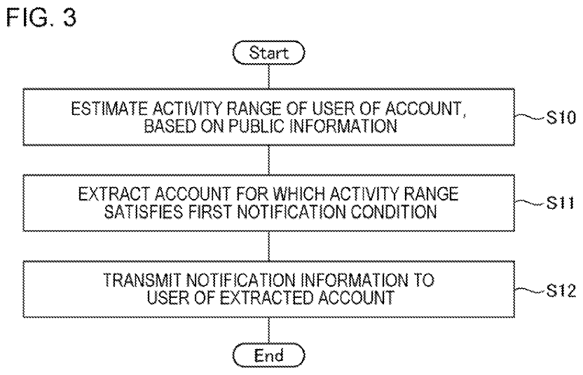

Next, one example of a flow of processing of the notification apparatus 10 is described by use of a flowchart in FIG. 3.

The following processing is started in response to occurrence of a predetermined event. The predetermined event is occurrence of a trouble such as a disaster, an accident, an incident, a fire, and a congestion, start of a road construction, road cleaning, or the like, and arrival of a time point a predetermined time before start of a road construction, road cleaning, or the like (30 minutes before the start or the like), input of a processing start instruction by an operator, arrival of a timing determined in advance, or the like.

When processing is started, the notification apparatus 10 generates location information indicating an activity range of a user of an account, based on public information that is associated with the account and is available on the Internet (S10). Then, the notification apparatus 10 extracts an account for which the location information satisfies a first notification condition (S11). Next, the notification apparatus 10 transmits notification information to the user of the extracted account (S12).

Note that, the processing in S10 is executed in response to occurrence of a predetermined event herein, but, as a modified example, processing in S10 is executed before occurrence of the predetermined event, and a location information indicating an activity range of each of users of a plurality of accounts may be generated. Then, the processing in each of Sll and S12 may be executed in response to occurrence of a predetermined event, based on location information generated in advance.

### “Effect”

The notification apparatus 10 according to the present example embodiment can generate location information indicating an activity range of a user of an account, based on public information that is associated with the account and is available on the Internet, and transmit notification information to the user of the account for which the location information satisfies a first notification condition. According to the notification apparatus 10 as above, only an appropriate user can be notified of appropriate information. As a result, a processing load on a computer can be reduced compared to a case of notifying all users of all pieces of information. Further, since information to be transmitted to a user can be restricted to only truly necessary information, inconvenience that attention of the user to information to be notified of is reduced can be suppressed, and inconvenience that that the user overlooks information to be notified of can be suppressed.

Note that, when it is determined whether an activity range of a user estimated based on public information available on the Internet rather than location information of a user acquired by utilizing a global positioning system (GPS) satisfies a predetermined condition, an advantageous effect that accuracy of restricting a user to be notified is increased is acquired.

### Second Example Embodiment

A notification apparatus 10 according to the present example embodiment transmits notification information to a user of an account that satisfies a condition of an activity range described in the first example embodiment and performs posting satisfying a predetermined condition. In other words, a user to transmit notification information to is more restricted. According to the notification apparatus 10 as above, only a more appropriate user can be notified of appropriate information.

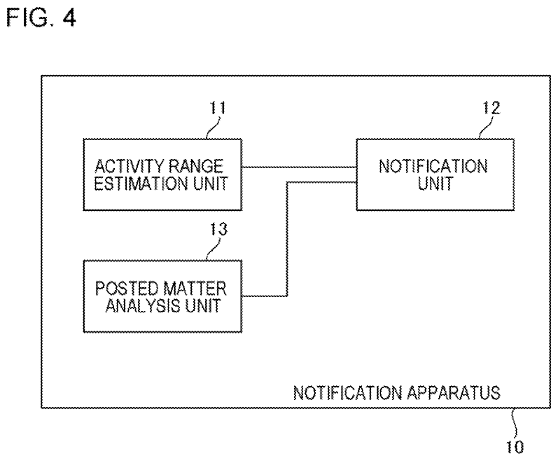

One example of a functional block diagram of the notification apparatus 10 is illustrated in FIG. 4. As illustrated, the notification apparatus 10 includes an activity range estimation unit 11, a notification unit 12, and a posted matter analysis unit 13.

The posted matter analysis unit 13 extracts an account performing posting satisfying a second notification condition, based on a posted matter that is associated with an account and is available on the Internet. A posted matter is a message, a still image, a moving image, a sound, or the like.

“Posting satisfying the second notification condition” includes at least one of posting of text data including a predetermined keyword, posting of text data with a predetermined content, posting of sound data including a predetermined keyword, posting of sound data with a predetermined content, posting of still image data indicating a predetermined situation, and posting of moving image data indicating a predetermined situation.

A “predetermined keyword” is a keyword related to a disaster, an accident, an incident, a fire, a congestion, or the like, and is exemplified by, but not limited to, “earthquake”, “fire”, “typhoon”, “heavy rain”, “traffic accident”, “○○ town”, “○○ intersection”, “snatching”, “robbery”, “burglary”, “kidnapping”, “illegal part-time job”, “bank transfer fraud”, or the like.

A “predetermined content” is a content indicating a disaster, an accident, an incident, a fire, a congestion, or the like. A content of a message included in text data or sound data can be determined by utilizing any technique of natural language processing.

A “predetermined situation” is a disaster, an accident, an incident, a fire, a congestion, or the like. It can be determined, by utilizing any image analysis technique (machine learning, deep learning, feature value matching, or the like), that still image data or moving image data indicate the situations.

Note that, posting satisfying the second notification condition may be posting satisfying not merely the above condition but also a temporal condition. The temporal condition is, for example, “posted within a most recent predetermined period”.

A “predetermined period” is set in advance in consideration of a period in which posting related to a trouble that has occurred is performed, a time in which an influence of a trouble that has occurred continues, or the like. A predetermined period may be set for each piece of notification information. For example, a predetermined period may be set for each piece of notification information, such as a predetermined period being relevant to notification information transmitted in response to occurrence of an earthquake, a predetermined period being relevant to notification information transmitted in response to various incidents such as snatching, robbery, burglary, kidnapping, or a predetermined period being relevant to notification information transmitted in response to detection of each of various keywords such as an illegal part-time job and a bank transfer fraud.

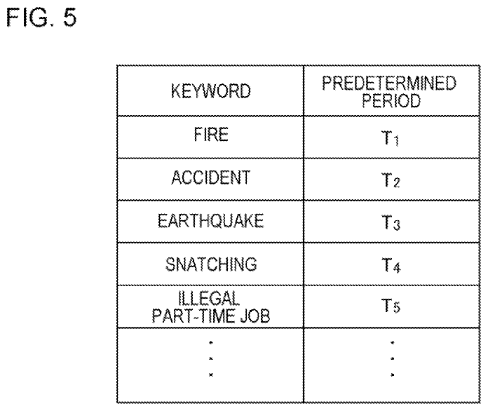

For example, posting satisfying the second notification condition may include at least one of posting of text data including a predetermined keyword within a most recent predetermined period, and posting of sound data including a predetermined keyword within a most recent predetermined period. Then, a predetermined period may differ for each predetermined keyword. FIG. 5 schematically illustrates one example of information defining a predetermined period for each of various keywords. The posted matter analysis unit 13 can determine a predetermined period, based on, for example, information such as that illustrated in FIG. 5.

In addition, posting satisfying the second notification condition may include at least one of posting of text data with a predetermined content within a most recent predetermined period, and posting of sound data with a predetermined content within a most recent predetermined period. Then, a predetermined period may differ for each predetermined content.

In addition, posting satisfying the second notification condition may include at least one posting of still image data indicating a predetermined situation within a most recent predetermined period and posting of moving image data indicating a predetermined situation within a most recent predetermined period. Then, a predetermined period may differ for each predetermined situation.

The notification unit 12 transmits notification information to a user of an account performing posting for which location information satisfies the first notification condition and satisfies the second notification condition.

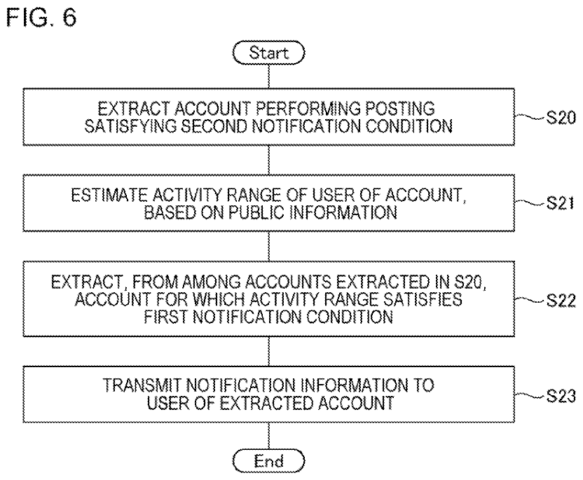

Next, one example of a flow of processing of the notification apparatus 10 is described by use of a flowchart in FIG. 6.

The following processing is started in response to occurrence of a predetermined event. The predetermined event is occurrence of a trouble such as a disaster, an accident, an incident, a fire, and a congestion, start of a road construction, road cleaning, or the like, and arrival of a time point a predetermined time before start of a road construction, road cleaning, or the like (30 minutes before the start or the like), input of a processing start instruction by an operator, arrival of a timing determined in advance, or the like.

When processing is started, the notification apparatus 10 extracts an account performing posting satisfying a second notification condition, based on a posted matter that is associated with an account and is available on the Internet (S20).

Next, the notification apparatus 10 generates location information indicating an activity range of the user of the account extracted in S20, based on public information that is associated with the account extracted in S20 and is available on the Internet (S21). Then, the notification apparatus 10 extracts, from among the accounts extracted in S20, an account for which location information satisfies the first notification condition (S22). Next, the notification apparatus 10 transmits notification information to the user of the extracted account (S23).

Note that, the processing in S21 is executed in response to occurrence of a predetermined event herein, but, as a modified example, the processing in S21 may be executed before occurrence of a predetermined event, and location information indicating an activity range of each of users of a plurality of accounts may be generated. Then, the processing in S20, S22, and S23 may be executed in this order, based on location information generated in advance, in response to occurrence of a predetermined event.

Other components of the notification apparatus 10 according to the present example embodiment are similar to those according to the first example embodiment.

The notification apparatus 10 according to the present example embodiment achieves an advantageous effect similar to that of the notification apparatus 10 according to the first example embodiment. Further, the notification apparatus 10 according to the present example embodiment can transmit notification information to a user of an account performing posting satisfying a condition of an activity range and satisfying a predetermined condition. As a result, it becomes possible to notify only a more appropriate user of appropriate information.

### Third Example Embodiment

A notification apparatus 10 according to the present example embodiment transmits notification information to a user of an account for which a condition of an activity range described in the first example embodiment is satisfied and attribute information determined based on public information satisfies a predetermined condition. In other words, a user to transmit notification information to is more restricted. According to the notification apparatus 10 as above, only a more appropriate user can be notified of appropriate information.

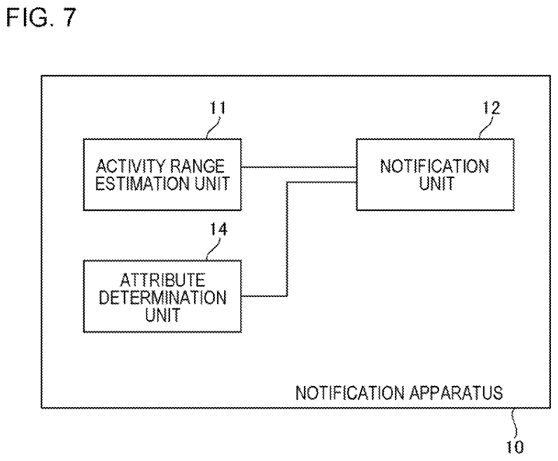

One example of a functional block diagram of the notification apparatus 10 is illustrated in FIG. 7. As illustrated, the notification apparatus 10 includes an activity range estimation unit 11, a notification unit 12, and an attribute determination unit 14.

The attribute determination unit 14 determines attribute information of a user of an account, based on public information that is associated with an account and is available on the Internet. Public information is as described in the first example embodiment.

“Attribute information” includes a gender, a date of birth, a nationality, an age (or a generation), a place of birth, a current place of residence, an affiliation, a school attended, and the like. The affiliation indicates a category to which a user belongs, such as a student or a member of society.

The notification unit 12 transmits notification information to a user of an account for which location information satisfies a first notification condition and attribute information satisfies a third notification condition.

The “third notification condition” is determined based on an item included in the attribute information. One example of the third notification condition is exemplified by, but not limited to, “minor”, “student”, “minor female”, “student female”, “minor male”, and “student male”.

Note that, the third notification condition may be set for each piece of notification information. For example, the third notification condition may be set for each piece of notification information, such as a third notification condition being relevant to notification information transmitted in response to occurrence of an earthquake, a third notification condition being relevant to notification information transmitted in response to occurrence of each of various incidents such as snatching, robbery, burglary, and kidnapping, and a third notification condition being relevant to notification information transmitted in response to detection of each of various keywords such as an illegal part-time job and a bank transfer fraud.

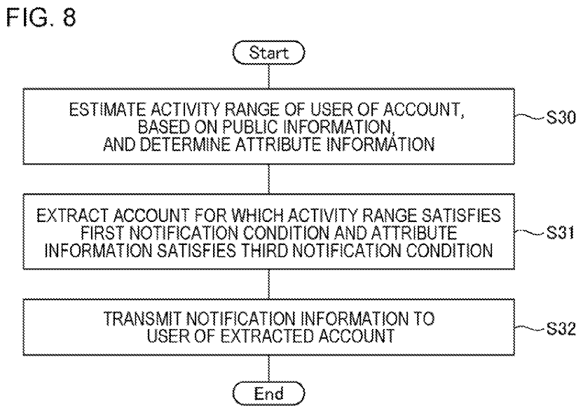

Next, one example of a flow of processing of the notification apparatus 10 is described by use of a flowchart in FIG. 8.

The following processing is started in response to occurrence of a predetermined event. The predetermined event is occurrence of a trouble such as a disaster, an accident, an incident, a fire, and a congestion, start of a road construction, road cleaning, or the like, and arrival of a time point a predetermined time before start of a road construction, road cleaning, or the like (30 minutes before the start or the like), input of a processing start instruction by an operator, arrival of a timing determined in advance, or the like.

When processing is started, the notification apparatus 10 generates location information indicating an activity range of a user of an account, based on public information that is associated with an account and is available on the Internet, and determines attribute information of the user (S30). Then, the notification apparatus 10 extracts an account for which location information satisfies a first notification condition and attribute information satisfies a third notification condition (S31). Next, the notification apparatus 10 transmits notification information to the user of the extracted account (S32).

Note that, the processing in S30 is executed in response to occurrence of a predetermined event herein, but, as a modified example, the processing in S30 may be executed before occurrence of a predetermined event, and location information indicating an activity range of each of users of a plurality of accounts may be generated. Then, the processing in S31 and S32 may be executed based on the location information generated in advance, in response to occurrence of a predetermined event.

Other components of the notification apparatus 10 according to the present example embodiment are similar to those according to the first and second example embodiments.

The notification apparatus 10 according to the present example embodiment achieves an advantageous effect similar to that of the notification apparatus 10 according to each of the first and second example embodiments. Further, the notification apparatus 10 according to the present example embodiment can transmit notification information to a user of an account satisfying a condition of an activity range and satisfying a condition of attribute information. As a result, it becomes possible to notify only a more appropriate user of appropriate information.

### Fourth Example Embodiment

A notification apparatus 10 according to the present example embodiment transmits notification information to a user of an account satisfying a condition of an activity range described in the first example embodiment, satisfying a condition of posting described in the second example embodiment, and satisfying a condition of attribute information described in the third example embodiment. In other words, a user to transmit notification information to is more restricted. According to the notification apparatus 10 as above, only a more appropriate user can be notified of appropriate information.

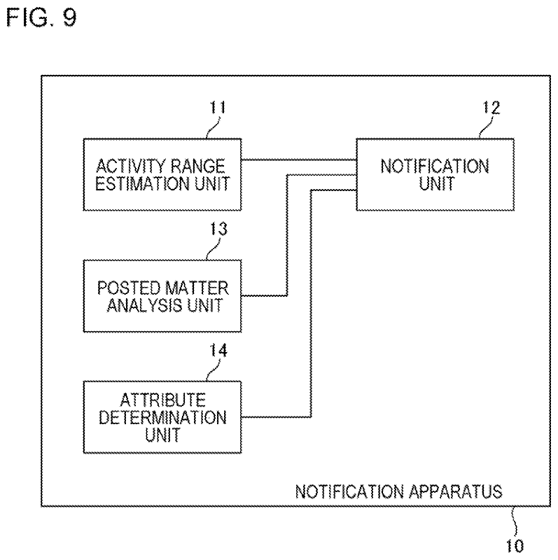

One example of a functional block diagram of the notification apparatus 10 is illustrated in FIG. 9. As illustrated, the notification apparatus 10 includes an activity range estimation unit 11, a notification unit 12, a posted matter analysis unit 13, and an attribute determination unit 14.

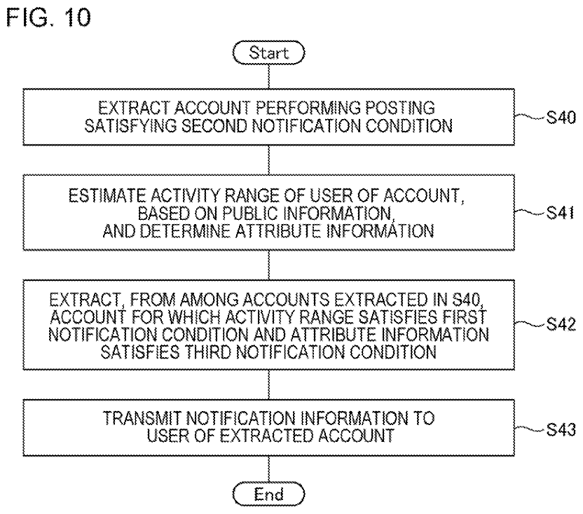

Next, one example of a flow of processing of the notification apparatus 10 is described by use of a flowchart in FIG. 10.

The following processing is started in response to occurrence of a predetermined event. The predetermined event is occurrence of a trouble such as a disaster, an accident, an incident, a fire, and a congestion, start of a road construction, road cleaning, or the like, and arrival of a time point a predetermined time before start of a road construction, road cleaning, or the like (30 minutes before the start or the like), input of a processing start instruction by an operator, arrival of a timing determined in advance, or the like.

When processing is started, the notification apparatus 10 extracts an account performing posting satisfying a second notification condition, based on a posted matter that is associated with an account and is available on the Internet (S40).

Next, the notification apparatus 10 generates location information indicating an activity range of the user of the account extracted in S40, based on public information that is associated with the account extracted in S40 and is available on the Internet, and determines attribute information of the user (S41). Then, the notification apparatus 10 extracts, from among the accounts extracted in S40 (S42), an account for which location information satisfies the first notification condition and attribute information satisfies the third notification condition. Next, the notification apparatus 10 transmits notification information to the user of the extracted account (S43).

Note that, the processing in S41 is executed in response to occurrence of a predetermined event herein, but, as a modified example, the processing in S41 may be executed before occurrence of a predetermined event, and location information indicating an activity range of each of users of a plurality of accounts may be generated. Then, the processing in S40, S42, and S43 may be executed in this order, based on location information generated in advance, in response to occurrence of a predetermined event.

Other components of the notification apparatus 10 according to the present example embodiment are similar to those according to the first to third example embodiments.

The notification apparatus 10 according to the present example embodiment achieves an advantageous effect similar to that of the notification apparatus 10 according to each of the first to third example embodiments. Further, the notification apparatus 10 according to the present example embodiment can transmit notification information to a user of an account satisfying a condition of an activity range, satisfying a condition of posting, and satisfying a condition of attribute information. As a result, it becomes possible to notify only a more appropriate user of appropriate information.

### Fifth example Embodiment

A notification apparatus 10 according to the present example embodiment differs from those according to the first to fourth example embodiments in transmitting notification information not merely to a user of an account determined by the method described in the first to fourth example embodiments, but also to a user satisfying a predetermined relationship with the former user.

As described in the first to fourth example embodiments, the notification unit 12 transmits notification information to “a user of an account for which location information satisfies a first notification condition”, “a user of an account performing posting for which location information the first notification condition and satisfies a second notification condition”, “a user of an account for which location information satisfies the first notification condition and attribute information satisfies a third notification condition”, or “a user of an account for which location information satisfies a first notification condition and attribute information satisfies the third notification condition and satisfies the second notification condition”.

Then, the notification unit 12 transmits notification information not merely to the user of the account, but also to a user having a predetermined relationship with the former user.

The “user having a predetermined relationship with the former user” may be at least one of a user having a mutually following relationship with the former user, a user followed by the former user, a user who follows the former user, and a user having an exchange history of a message with the former user. Other components of the notification apparatus 10 according to the present example embodiment are similar to those according to the first to fourth example embodiments.

The notification apparatus 10 according to the present example embodiment achieves an advantageous effect similar to that of the notification apparatus 10 according to each of the first to fourth example embodiments. Further, the notification apparatus 10 according to the present example embodiment can transmit notification information not merely to a user of an account satisfying a condition of an activity range or the like, but also to a user having a predetermined relationship with the former user. As a result, it becomes possible to notify only a more appropriate user of appropriate information.

### Application Example

An example in which the notification apparatus 10 according to each of the first to fifth example embodiments is applied is described below. Note that, the example is only one example, and the present invention is not limited to the example.

### Application Example 1

In the example, the notification apparatus 10 is configured in such a way as to transmit notification information to a user of an account posting text data or sound data including a keyword such as “earthquake”, “typhoon”, and “heavy rain”, or a still image or a moving image showing such a situation, and having an activity range included in an area where a risk of “tsunami”, “flooding of a river”, “flooding”, “landslide”, or the like is equal to or more than a predetermined level. The notification apparatus 10 can acquire, for example, information provided by a predetermined server, and determine, based on the information, an area where a risk of “tsunami”, “river flooding”, “flooding”, “landslide”, or the like is equal to or more than a predetermined level. The information provided by the predetermined server is, for example, information indicating an area where the risk is equal to or more than a predetermined level.

### Application Example 2

In this example, the notification apparatus 10 performs notification processing, based on a request from an insurance company that performs attention calling using notification information. The notification apparatus 10 is configured in such a way as to transmit notification information to a user of an account posting text data or sound data including a keyword such as “earthquake”, “typhoon”, and “heavy rain”, or a still image or a moving image showing such a situation, having an activity range included in an area where a risk of “tsunami”, “flooding of a river”, “flooding”, “landslide”, or the like is equal to or more than a predetermined level, and having attribute information satisfying “policyholder”. The notification apparatus 10 can acquire, for example, information provided by a predetermined server, and determine, based on the information, an area where a risk of “tsunami”, “river flooding”, “flooding”, “landslide”, or the like is equal to or more than a predetermined level. The information provided by the predetermined server is, for example, information indicating an area where the risk is equal to or more than a predetermined level. Detection of a user of an account for which attribute information satisfies a policyholder is achieved by use of, for example, a database of a policyholder prepared in advance. Account information, an e-mail address, and the like of the policyholder are registered in the database. The notification apparatus 10 can determine whether a user of each account is a policyholder by determining whether the user is registered in the database.

### Application Example 3

In this example, the notification apparatus 10 is configured in such a way as to transmit notification information to a user of an account posting text data including a keyword such as “illegal part-time job”, “bank transfer fraud”, or “drug”, having an activity range in a jurisdiction of an organization that performs attention calling using notification information, and having attribute information satisfying at least one of “student” and “minor”.

The example embodiments according to the present invention have been described above with reference to the drawings, but are exemplifications of the present invention, and various configurations other than those described above can be adopted. The components according to the example components described above may be combined with each other, or some of the components may be replaced with other components. Further, various modifications may be made to the components according to the above-described example embodiments without departing from the scope of the invention. Further, the components and processing disclosed in each of the above example embodiments and modified examples may be combined with each other.

Note that, in the present specification, “acquisition” includes at least one of “fetching, by a local apparatus, data stored in another apparatus or a storage medium (active acquisition)”, for example, receiving by requesting or inquiring of the another apparatus, accessing the another apparatus or the storage medium and reading, and the like, based on a user input, or based on an instruction of a program, “inputting, into a local apparatus, data output from another apparatus (passive acquisition)”, for example, receiving data given by distribution (or transmission, push notification, or the like), selecting and acquiring from received data or information, based on a user input, or based on an instruction of a program, and “generating new data by editing of data (conversion into text, rearrangement of data, extraction of partial data, changing of a file format, or the like) or the like, and acquiring the new data”.

Some or all of the above-described example embodiments can also be described as, but are not limited to, the following supplementary notes.
1. A notification apparatus including:
   an activity range estimation unit that generates location information indicating an activity range of a user of an account, based on public information that is associated with the account and is available on the Internet: and
   a notification unit that transmits notification information to a user of the account for which the location information satisfies a first notification condition.
2. The notification apparatus according to supplementary note 1, further including
   a posted matter analysis unit that extracts the account performing posting satisfying a second notification condition, based on a posted matter that is associated with the account and is available on the Internet, wherein
   the notification unit transmits the notification information to a user of the account for which the location information satisfies the first notification condition and the account performs posting satisfying the second notification condition.
3. The notification apparatus according to supplementary note 1, further including
   an attribute determination unit that determines attribute information of a user of the account, based on the public information, wherein
   the notification unit transmits the notification information to a user of the account for which the location information satisfies the first notification condition and the attribute information satisfies a third notification condition.
4. The notification apparatus according to supplementary note 3, further including
   a posted matter analysis unit that extracts the account performing posting satisfying a second notification condition, based on a posted matter that is associated with the account and is available on the Internet, wherein
   the notification unit transmits the notification information to a user of the account for which the location information satisfies the first notification condition, the attribute information satisfies the third notification condition, and the account performs posting satisfying the second notification condition.
5. The notification apparatus according to supplementary note 2 or 4, wherein
   posting satisfying the second notification condition includes at least one of posting of text data including a predetermined keyword, posting of text data with a predetermined content, posting of sound data including the predetermined keyword, posting of sound data with the predetermined content, posting of still image data indicating a predetermined situation, and posting of moving image data indicating the predetermined situation.
6 The notification apparatus according to supplementary note 5, wherein
   posting satisfying the second notification condition includes at least one of posting of text data including the predetermined keyword, and posting of sound data including the predetermined keyword, within a most recent predetermined period, and
   the predetermined period differs for each of the predetermined keywords.
7 The notification apparatus according to supplementary note 5, wherein
   posting satisfying the second notification condition includes at least one of posting of text data with the predetermined content, and posting of sound data with the predetermined content, within a most recent predetermined period, and
   the predetermined period differs for each of the predetermined contents.
8. The notification apparatus according to supplementary note 5, wherein
   posting satisfying the second notification condition includes at least one of posting of still image data indicating the predetermined situation, and posting of moving image data indicating the predetermined situation, within a most recent predetermined period, and
   the predetermined period differs for each of the predetermined situations.
9. The notification apparatus according to any one of supplementary notes 1 to 8, wherein
   the notification unit transmits the notification information not merely to a user of the account for which the location information satisfies the first notification condition, but also to a user satisfying a predetermined relationship with a user of the account for which the location information satisfies the first notification condition.
10. A notification method including,
   executing by a computer:
      an activity range estimation process of generating location information indicating an activity range of a user of an account, based on public information that is associated with the account and is available on the Internet: and
      a notification process of transmitting notification information to a user of the account for which the location information satisfies a first notification condition.
11. A program causing a computer to function as:
   an activity range estimation unit that generates location information indicating an activity range of a user of an account, based on public information that is associated with the account and is available on the Internet: and
   a notification unit that transmits notification information to a user of the account for which the location information satisfies a first notification condition.

### REFERENCE SIGNS LIST

10 Notification apparatus
11 Activity range estimation unit
12 Notification unit
13 Posted matter analysis unit
14 Attribute determination unit
1A Processor
2A Memory
3A Input/output I/F
4A Peripheral circuit
5A Bus

What is claimed is:

1. A notification apparatus comprising:
at least one memory configured to store one or more instructions; and
at least one processor configured to execute the one or more instructions to:
generate location information indicating an activity range of a user of an account, based on public information that is associated with the account and is available on the Internet; and
transmit notification information to a user of the account for which the location information satisfies a first notification condition.

2. The notification apparatus according to claim 1, wherein the at least one processor is further configured to execute the one or more instructions to
extract the account performing posting satisfying a second notification condition, based on a posted matter that is associated with the account and is available on the Internet, wherein and
transmit the notification information to a user of the account for which the location information satisfies the first notification condition and the account performs posting satisfying the second notification condition.

3. The notification apparatus according to claim 1, wherein the at least one processor is further configured to execute the one or more instructions to
determine attribute information of a user of the account, based on the public information, wherein and
transmit the notification information to a user of the account for which the location information satisfies the first notification condition and the attribute information satisfies a third notification condition.

4. The notification apparatus according to claim 3, wherein the at least one processor is further configured to execute the one or more instructions to
extract the account performing posting satisfying a second notification condition, based on a posted matter that is associated with the account and is available on the Internet, and
transmit the notification information to a user of the account for which the location information satisfies the first notification condition, the attribute information satisfies the third notification condition, and the account performs posting satisfying the second notification condition.

5. The notification apparatus according to claim 2, wherein
posting satisfying the second notification condition includes at least one of posting of text data including a predetermined keyword, posting of text data with a predetermined content, posting of sound data including the predetermined keyword, posting of sound data with the predetermined content, posting of still image data indicating a predetermined situation, and posting of moving image data indicating the predetermined situation.

6. The notification apparatus according to claim 5, wherein
posting satisfying the second notification condition includes at least one of posting of text data including the predetermined keyword, and posting of sound data including the predetermined keyword, within a most recent predetermined period, and
the predetermined period differs for each of the predetermined keywords.

7. The notification apparatus according to claim 5, wherein
posting satisfying the second notification condition includes at least one of posting of text data with the predetermined content, and posting of sound data with the predetermined content, within a most recent predetermined period, and
the predetermined period differs for each of the predetermined contents.

8. The notification apparatus according to claim 5, wherein
posting satisfying the second notification condition includes at least one of posting of still image data indicating the predetermined situation, and posting of moving image data indicating the predetermined situation, within a most recent predetermined period, and
the predetermined period differs for each of the predetermined situations.

9. The notification apparatus according to claim 1, wherein the at least one processor is further configured to execute the one or more instructions to
transmit the notification information not merely to a user of the account for which the location information satisfies the first notification condition, but also to a user satisfying a predetermined relationship with a user of the account for which the location information satisfies the first notification condition.

10. A notification method comprising,
executing by a computer:
generating location information indicating an activity range of a user of an account, based on public information that is associated with the account and is available on the Internet; and
transmitting notification information to a user of the account for which the location information satisfies a first notification condition.

11. A non-transitory storage medium storing a program causing a computer to:
generate location information indicating an activity range of a user of an account, based on public information that is associated with the account and is available on the Internet; and
transmit notification information to a user of the account for which the location information satisfies a first notification condition.

12. The notification method according to claim 10, wherein the computer
extracts the account performing posting satisfying a second notification condition, based on a posted matter that is associated with the account and is available on the Internet, and
transmits the notification information to a user of the account for which the location information satisfies the first notification condition and the account performs posting satisfying the second notification condition.

13. The notification method according to claim 10, wherein the computer
determines attribute information of a user of the account, based on the public information, and
transmits the notification information to a user of the account for which the location information satisfies the first notification condition and the attribute information satisfies a third notification condition.

14. The notification method according to claim 13, wherein the computer
extracts the account performing posting satisfying a second notification condition, based on a posted matter that is associated with the account and is available on the Internet, and
transmits the notification information to a user of the account for which the location information satisfies the first notification condition, the attribute information satisfies the third notification condition, and the account performs posting satisfying the second notification condition.

15. The notification method according to claim 12, wherein
posting satisfying the second notification condition includes at least one of posting of text data including a predetermined keyword, posting of text data with a predetermined content, posting of sound data including the predetermined keyword, posting of sound data with the predetermined content, posting of still image data indicating a predetermined situation, and posting of moving image data indicating the predetermined situation.

16. The notification method according to claim 15, wherein
posting satisfying the second notification condition includes at least one of posting of text data including the predetermined keyword, and posting of sound data including the predetermined keyword, within a most recent predetermined period, and
the predetermined period differs for each of the predetermined keywords.

17. The non-transitory storage medium according to claim 11, wherein the program causing the computer to
extract the account performing posting satisfying a second notification condition, based on a posted matter that is associated with the account and is available on the Internet, and
transmit the notification information to a user of the account for which the location information satisfies the first notification condition and the account performs posting satisfying the second notification condition.

18. The non-transitory storage medium according to claim 11, wherein the program causing the computer to
determine attribute information of a user of the account, based on the public information, and
transmit the notification information to a user of the account for which the location information satisfies the first notification condition and the attribute information satisfies a third notification condition.

19. The non-transitory storage medium according to claim 18, wherein the program causing the computer to
extract the account performing posting satisfying a second notification condition, based on a posted matter that is associated with the account and is available on the Internet, and
transmit the notification information to a user of the account for which the location information satisfies the first notification condition, the attribute information satisfies the third notification condition, and the account performs posting satisfying the second notification condition.

20. The non-transitory storage medium according to claim 17, wherein
posting satisfying the second notification condition includes at least one of posting of text data including a predetermined keyword, posting of text data with a predetermined content, posting of sound data including the predetermined keyword, posting of sound data with the predetermined content, posting of still image data indicating a predetermined situation, and posting of moving image data indicating the predetermined situation.
